(19) United States
(12) Patent Application Publication
(10) Pub. No.: US 2023/0400174 A1
(43) Pub. Date: Dec. 14, 2023

(54) Lantern Pole

(71) Applicant: TANAQRO. Co., Ltd., Saitama-shi (JP)

(72) Inventor: Masato Nagatsuma, Tokyo (JP)

(21) Appl. No.: 18/207,328

(22) Filed: Jun. 8, 2023

(30) Foreign Application Priority Data
Jun. 9, 2022 (JP) 2022-093966

(51) Int. Cl. F21V 21/14

(52) U.S. Cl. CPC F21V 21/145

(57) ABSTRACT

The lantern pole includes a pole part, a rope part, a bracket part, and a peg part. The pole part is provided with a hook at the upper part to hang a lantern. The bracket part connects the rope part and the peg part, and the pole part bends by pulling said rope part. The installation position of the lantern can be arranged depending on the strength of the pull.

### CROSS-REFERENCE TO RELATED APPLICATION

This application claims priority to Japanese Patent Application No. 2022-093966 filed Jun. 9, 2022, the disclosure of which is hereby incorporated by reference in its entirety.

### BACKGROUND OF THE INVENTION

### Field of the Invention

The present invention relates to a lantern pole for supporting lanterns used outdoors such as in camping.

### Description of Related Art

As for a conventional lantern pole, there is a tripod type which can be used stably on flat ground, but on uneven ground, had the problem of tipping over when touched or hit a little. Accordingly, rather than a “tripod type”, there is a lantern stand made a “drive in the ground type” which enables stable standing. However, when it is a “drive in type”, the peg has to be driven in perpendicular to the ground to keep the pole perpendicular, therefore takes big effort to install it neatly perpendicular, and further, the drive in part (peg part) gets deformed by impact and the connection with the pole body becomes poor. Moreover, a lantern hung to a conventional lantern pole was unsuitable to illuminate directly above a table.

### SUMMARY OF THE INVENTION

Therefore, a lantern pole which takes little effort to drive in, and can illuminate directly above a table, etc. was required.

The present invention has been proposed in view of such circumstances.

Namely, a lantern pole which, when driving in, does not have to be driven in perpendicular to the ground but can be driven in roughly, and when in use, can illuminate directly above a table, etc.

The present application is a lantern pole in which the lantern pole is comprising a pole part, a rope part, a bracket part, and a peg part, wherein said pole part is provided with a hook at the upper part to hang a lantern, said bracket part connects said rope part and said peg part, and wherein said pole part bends by pulling said rope part, and the installation position of said lantern can be arranged depending on the strength of the pull.

It is a lantern pole, wherein said rope part has a wire part and a tape part and an adjusting part, wherein said wire part and said tape part are connected, said tape part is adjustable in length with said adjusting part, and wherein the bending degree of said pole part is adjusted with said adjusting part.

The present application is easy to install, because such that the pole ultimately becomes a curved shape, it is not necessary to drive in the peg perpendicular to the ground and can be driven in roughly. Moreover, since the peg and the pole are connected with the bracket, there is no problem even if the peg gets deformed by impact. Moreover, conventionally, to suspend a lantern to a pole, a suspension rod is provided perpendicular to the pole (parallel to the ground) at the upper part of the pole and a hook is provided at its tip, but since that the pole bends in the present application, a hook can be provided directly at the tip of the upper art of the pole without a suspension rod.

A lantern hung to a conventional lantern pole is not unsuitable to illuminate directly above a table, but the lantern pole of the present application can be installed to illuminate directly above a table taking advantage of the curved shape. Moreover, when not required, the position of the lantern can be changed instantly by loosening the tension of the pole part with said adjusting part.

The lantern pole of the present application forms the pole in a straight state into an arc shape by pulling the rope part. If it is tried to form an arc without making arrangement with the rope part, but only with the weight of the lantern and the pole, the elastic stress and length of the pole and the weight of the lantern becomes limited to draw an ideal arc. Moreover, if there is no rope part, it will easily swing by wind, etc. However, if there is a rope part, the attitude is kept by the balance between the elasticity of the pole and the tensile strength of the rope part, so even if a lantern is attached at the tip of the pole, the effect of wind can also be alleviated.

### BRIEF DESCRIPTION OF THE DRAWINGS

FIG. 1 A perspective view pertaining to the lantern pole of the present invention.

FIG. 2 A front elevational view pertaining to the lantern pole of the present invention.

FIG. 3 A left side elevational view pertaining to the lantern pole of the present invention.

FIG. 4 A front elevational view of the wire part.

FIG. 5 A front elevational view and a plan view of the bracket part.

FIG. 6 A front elevational view of the peg part and its sectional view.

### DESCRIPTION OF THE INVENTION

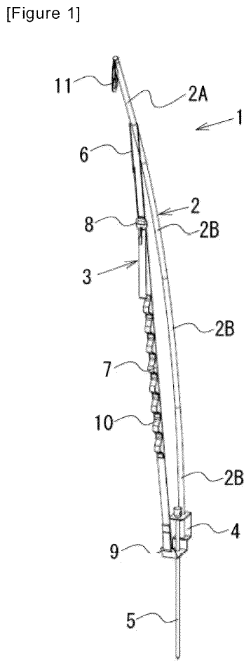

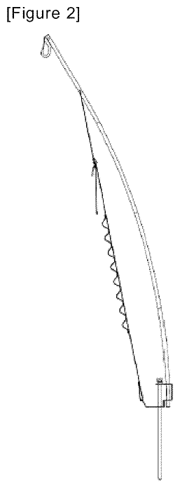

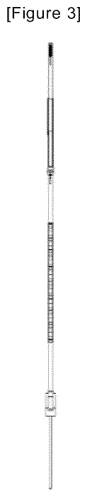

Embodiments of the lantern pole of the present invention will be described below using drawings.
FIG. 1 is a perspective view showing the lantern pole of the present invention, FIG. 2 is a front elevational view of the present lantern pole, and FIG. 3 is a left side elevational view of the lantern pole.
The lantern pole 1 broadly has a pole part 2, a rope part 3, a bracket part 4, and a peg part 5.
The pole part 2 comprises a pole 2A having a hook part 11 to hang a lantern at the tip, and plural poles 2B. The pole 2A and plural poles 2B are linked at use. There are three poles 2B in FIG. 1, but the number of poles 2B is not particularly limited to.
The rope part 3 has a wire part 6 and a tape part 7 and an adjusting part 8. The pole part 2 is originally straight, but the pole part 2 can be bent by pulling the rope part. The pole part 2 can be bent by shortening the length of the tape connected to the wire with the adjusting part 8, not by directly pulling the wire of the rope part to bend the pole part.
The bending degree of the pole part 2 can be adjusted with the adjusting part 8.
The tape part 7 is a Daisy Chain having plural loops 10 in FIG. 1, but is not limited to, and may not have loops 10.
The tape part 7 is drawn through a hole part 9 of the bracket part 4.

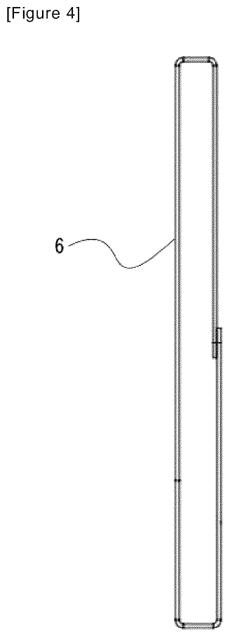

FIG. 4 is a front elevational view of the wire part 6. The tape is drawn through the lower side of the wire ring. The material of the wire is preferable to have strength to some extent, and is preferable to resist heat even when the lantern is a gas or oil combustion type. Wires of stainless steel, etc. are most preferred, and when it is stainless steel, the same degree as SUS304 (JIS) is sufficient. However, not limited to it.

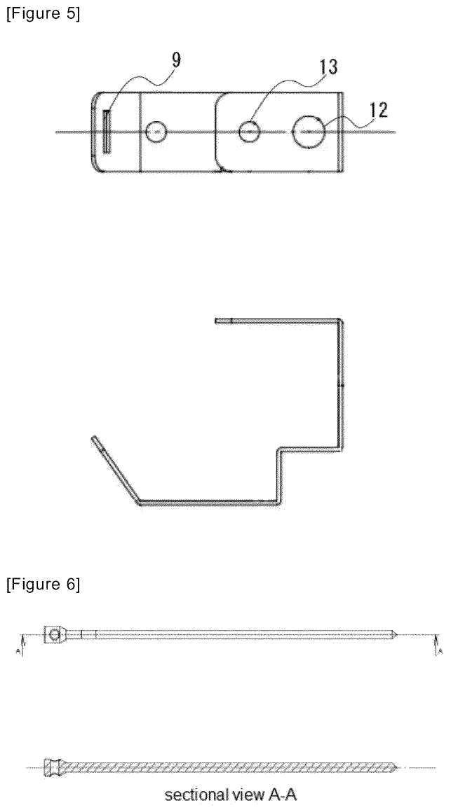

FIG. 5 is a front elevational view and a plan view of the bracket part 4. The bracket part 4 is for fixing and connecting the pole part 2 and the peg part 5, and has a hole part 12 to insert the pole part 2 and a hole part 13 to insert the peg part 5. The tape part 7 is drawn through the hole part 9.

It is preferable that the material of the pole part has strength and flexes moderately. The diameter of the pole varies according to the strength of the material. The pole part of the present application is preferable when it is a round pole made of aluminum, and its diameter is 12 mm to 14 mm. A7075 (JIS) is an example for aluminum, and other than that, carbon or fiberglass, etc. are also preferable.

FIG. 6 is a front elevational view of the peg part 5 and its sectional view. It is preferable that the peg part can comply widely with soft grounds to hard grounds, has strength and fixing force, and is able to firmly support the pole even if the wind blows. A hot forged peg is preferable, but is not limited to.

The present invention provides a lantern pole which takes little effort to drive in, and can adjust the bending of the pole part to illuminate directly above a table, etc.

### EXPLANATION OF REFERENCES

1 lantern pole
2 pole part
3 rope part
4 bracket part
peg part
6 wire part
7 tape part
8 adjusting part
9 hole part of the bracket part
10 loop
11 hook part
12 hole part of the bracket part
13 hole part of the bracket part

1. A lantern pole comprising a pole part, a rope part, a bracket part, and a peg part, wherein
said pole part is provided with a hook at the upper part to hang a lantern,
said bracket part connects said rope part and said peg part, and wherein
said pole part bends by pulling said rope part, and
the installation position of said lantern is arranged depending on the strength of the pull.

2. The lantern pole according to claim 1, wherein
said rope part has a wire part and a tape part and an adjusting part, wherein
said wire part and said tape part are connected, said tape part is adjustable in length with said adjusting part, and wherein
the bending degree of said pole part is adjusted with said adjusting part.
